(19) United States
(12) Patent Application Publication
(10) Pub. No.: US 2004/0146449 A1
(43) Pub. Date: Jul. 29, 2004

(54) Gases and gas mixtures typically capable of conversion to supercritical fluids or dense phase gases formed from liquid precursors, apparatus for making said gases and gas mixtures, and products made using them

(76) Inventors: Martyn Poliakoff, Nottinghamshire (GB); Jason Robert Hyde, Nottingham (GB)

Correspondence Address: BAKER & BOTTS, 30 ROCKEFELLER PLAZA, NEW YORK, NY, 10112

(21) Appl. No.: 10/473,556

(22) PCT Filed: Apr. 2, 2002
(86) PCT No.: PCT/GB02/01246

(30) Foreign Application Priority Data
Mar. 31, 2001 (GB) 0108151.2

(51) Int. Cl. C01B 31/20

(52) U.S. Cl. 423/437.1

(57) ABSTRACT

A gas or mixture of gases is produced by decomposition or chemical reaction of liquid precursor(s). The gas may be converted to a dense phase gas or supercritical fluid state which can be used as a medium for chemical reaction, chromatography, extraction or impregnation/modification. Changes in the gas composition may be made simply by modification of the metered flow rates or chemical composition of the liquid precursor(s).

This invention relates to the production of a gas or mixture of gases, typically but not necessarily for chemical reaction or chromatography, extraction or impregnation/modification of solid substrates; and to apparatus for making gas mixtures and or reacting gases in a gas mixture, and to materials made from the reactions.

The invention arose from considerations relating to the production of supercritical fluids and it is convenient to discus the invention in that context, but is not restricted to supercritical fluids.

It is sometimes desired to have a mixture of gases. This may be because it is desired to react the gases together, or with another substance. It may be because the gases are wanted for some other purpose. It is currently difficult to generate gas mixtures with a controlled composition and our invention is particularly useful in this respect.

Currently, supercritical fluid or dense phase gas formation is achieved by compressing a gas such as carbon dioxide (or a mixture of gases) to, near or above its critical pressure and heating to, near or above its critical temperature. This process requires the use of gas storage cylinders and equipment capable of withstanding high pressure. Also, the use of high-pressure pumps is required to achieve the supercritical state. Currently laboratory-scale supercritical fluids reactors are limited by the control of dosing of secondary gases into the supercritical fluid, and mass-flow control is difficult.

Supercritical fluids can be used as a medium for performing chemical reactions such as hydrogenation, acylation, alkylation, transesterification, etherification and cyclisation, or for use, for example in chromatography, extraction and impregnation. On a small scale, such as is currently used for laboratory screening, it is difficult both to meter the flow of gas and accurately to measure and maintain the composition of the fluid.

We have unexpectedly found that at least some of the foregoing disadvantages can be eliminated or reduced by producing supercritical fluids from liquid precursors instead of from gases. This invention circumvents problems by use of liquid precursor(s) to generate the dense phase gas mixture or supercritical fluid.

Accordingly, in one embodiment of the present invention we provide a method for the production of a supercritical fluid or dense phase gas in which at least one liquid precursor of said supercritical fluid or dense phase gas is chemically reacted, or is decomposed to form a gas.

The liquid precursor may be decomposed over a catalyst, or alternatively by means of energy input, for example, heat, light, sound, another energy source.

The gas or gas mixture produced may be conveyed to a reaction chamber or zone for the performance of chemical reactions. The gas or gas mixture may take part in the reactions or not.

We may also provide a supercritical fluid or dense phase gas made by the method described in the preceding paragraphs. We may also provide a reaction product of a chemical reaction that occurs in a supercritical fluid or dense phase gas produced by the method.

The liquid precursors are selected according to the chemical reaction and supercritical fluid desired. In principle, the precursor may be any substance that decomposes, can be decomposed or reacted to form a gas. For example, the liquid precursor may be an organic acid, or a salt or an ester of an organic acid, for example formic acid. For performing hydrogenation reactions the precursors are preferably formic acid and ethyl formate. Alternatively, methyl formate, ethyl formate, propyl formate or dimethyl carbonate, or any mixture thereof, may be used to yield gas mixtures of methane and carbon dioxide, ethane and carbon dioxide, carbon monoxide and propane and water, methane and carbon dioxide respectively.

When the decomposition method involves a catalyst, the catalyst may comprise any catalytically-active species. The catalyst may comprise rhodium, iridium, palladium or platinum. The catalyst is preferably supported, in a finely-divided condition, on an inert support. Such an inert support may be silica, or alumina, or an alumosilicate.

Formic acid decomposes over a metal catalyst at elevated temperature to form carbon dioxide and hydrogen. Under the conditions of the decomposition in accordance with one aspect of the present invention, a single-phase gas mixture is obtained. The gas mixture in this case comprises carbon dioxide and hydrogen in a 1:1 ratio. Variation of that ratio is impossible to achieve when the liquid precursor is formic acid alone and formation of a supercritical fluid is difficult. However, we have found that ethyl formate decomposes, under similar conditions, to form CO₂ and ethane (C₂H₆). Ethane has a similar critical temperature to CO₂.

Thus, when ethyl formate and formic acid are decomposed simultaneously, a gas mixture is formed (CO₂+H₂ from the formic acid and CO₂ and C₂H₆ from the ethyl formate) which has more easily accessible critical conditions and is more easily formed into a supercritical fluid.

The stoichiometry of said supercritical fluid, i.e. the ratio of CO₂ and ethane to H₂, may be controlled by adjusting the rate at which the formic acid and the ethyl formate flow over the same catalyst bed.

It is important in this example that the precursors are not pre-mixed before they enter the reaction chamber, to prevent undesirable hydrolysis reactions.

This method may be used such that the reactions may be carried out, in dense phase gases or supercritical fluids for example, hydrogenation reactions, Friedel-Crafts acylation and alkylation reactions, transesterification, etherification, hydrogenolysis, deprotection and cyclisation reactions, depending upon the composition of the supercritical fluid formed by the chosen precursor(s) and on the catalyst employed.

According to another aspect the invention comprises a method of producing a multi-component gas mixture having a first gas component and a second gas component comprising the steps of storing a precursor to the first gas component in liquid form and turning the precursor into said first gas component by chemical reaction or decomposition, preferably upon demand, and/or preferably in situ at or near to a gas mixing chamber at which said first gas component encounters a second gas component.

By “at or near” to the gas mixing, or gas receiving, chamber we mean near enough to greatly reduce the volume of the components of the gas mixture present at a given time when compared with the situation where the components are held outside of the mixing chamber in storage cylinders or tanks. Preferably we react or decompose the precursor into gaseous form upon demand:—i.e. when it is desired to produce the gas. This avoids the need to store gas for a long time prior to using the gas.

The gas receiving chamber may be a zone or region of a pipe, or it may be an enlarged chamber, of greater cross-sectional area than that of a first and/or second precursor delivery conduit. Delivery conduits may deliver liquid components to the chamber where the liquid components gasify, or they may deliver gaseous first and/or second components to the chamber. There may be 2, 3, 4, 5, or more components.

The reaction may occur with the gas components in a gaseous or fluid state. Alternatively the gas mixture may be in a supercritical fluid, or dense phase gas, state.

Preferred embodiments of the invention will now be illustrated, merely by way of example, but should not be taken as limiting on the scope of this method to one skilled in the art, in the following description and with reference to the accompanying drawings, of which:—

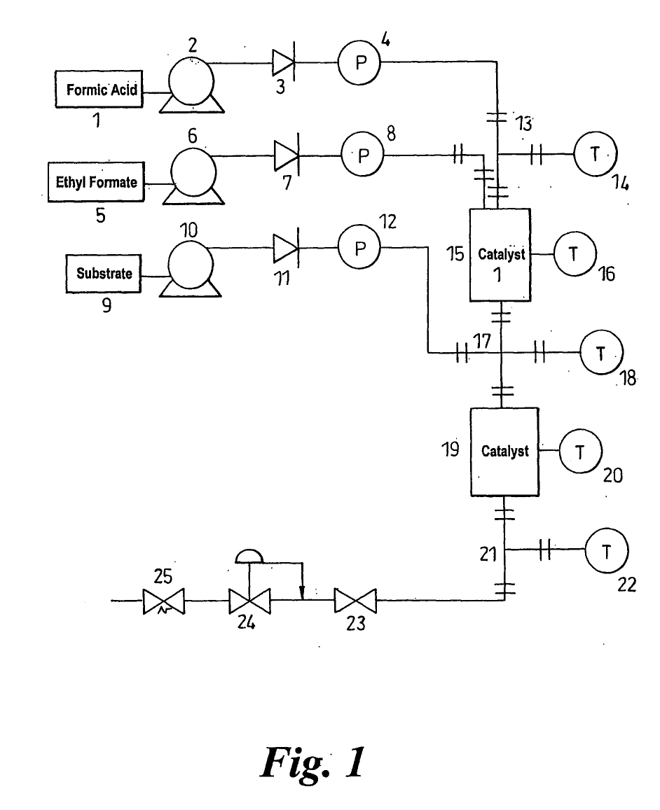

FIG. 1 shows a flow diagram of a reactor for the production and subsequent use of supercritical fluids according to the present invention;

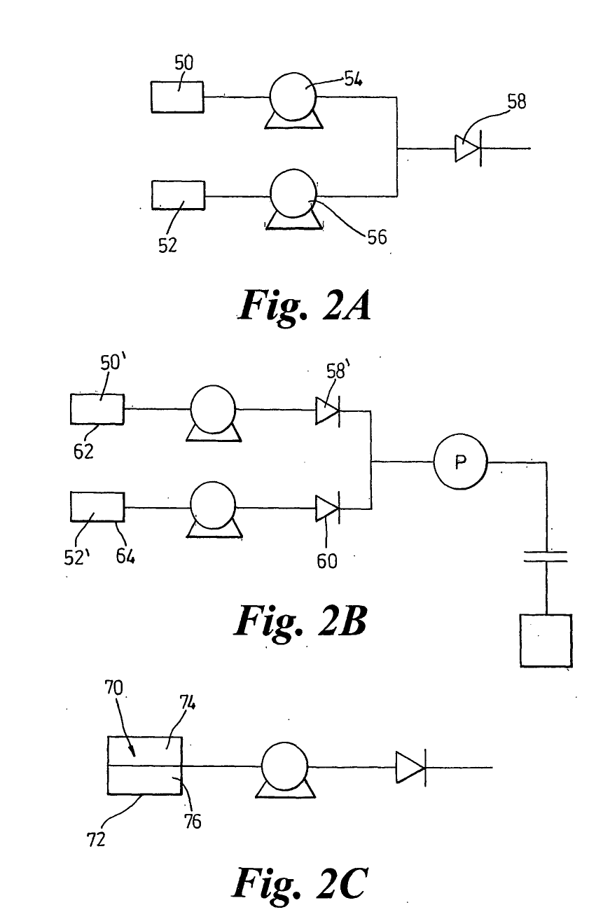

FIGS. 2A to 2C show modifications of feeds of precursor liquids;

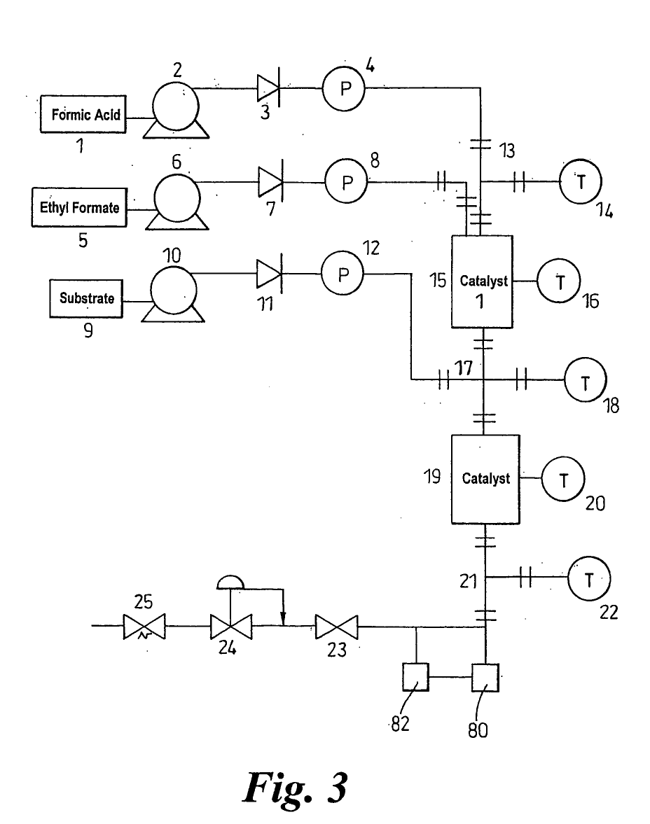

FIG. 3 shows a modified plant similar to that of FIG. 1;

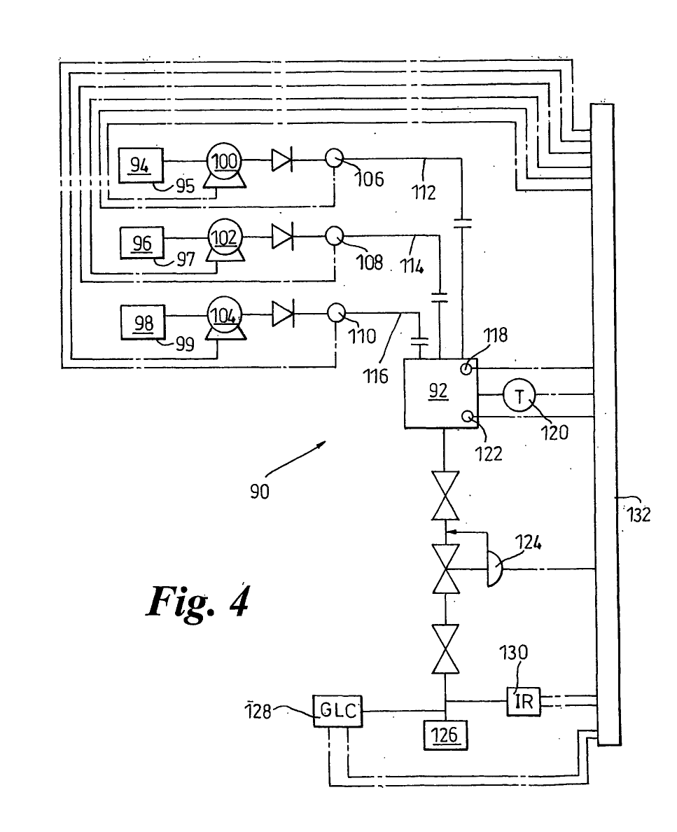

FIG. 4 shows a computer-controlled micro-reactor plant; and

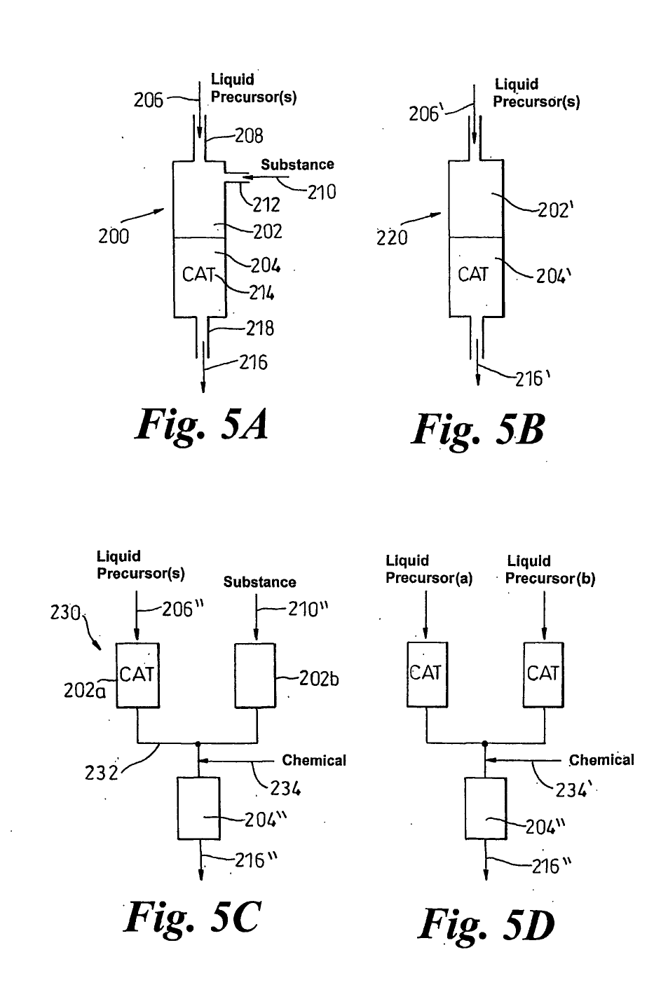

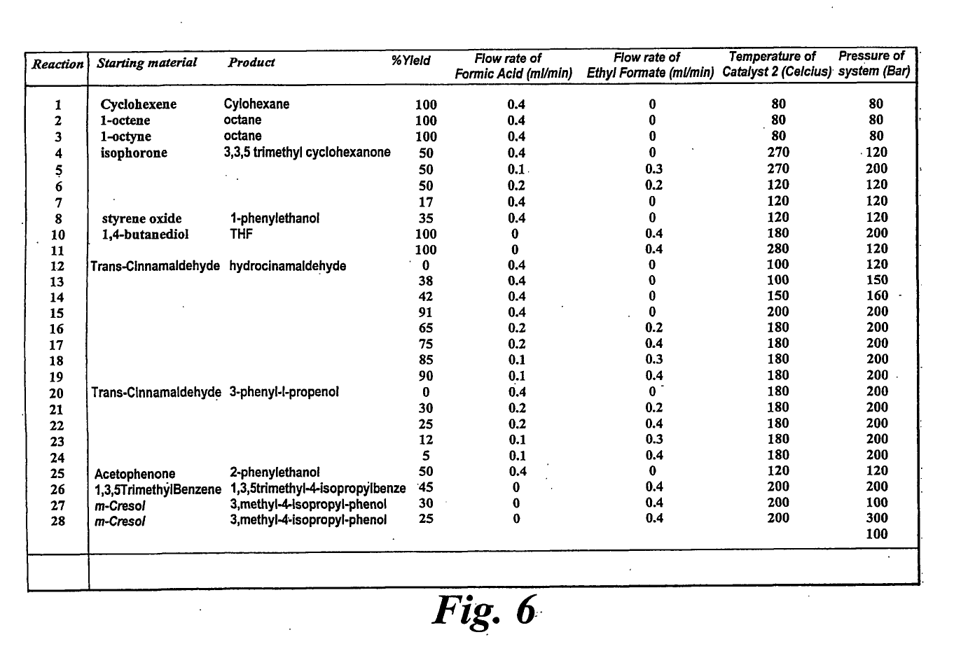

FIGS. 5a-5c shows different gas generator and chemical reactor configurations.

Referring to FIG. 1, the reactor comprises two reservoirs, 1 and 5, for the liquid precursors and a reservoir 9, for a substrate. High-pressure pumps 2, 6 and 10 are each provided with a non-return valve 3, 7 and 11 respectively and a pressure monitor, 4, 8 and 12 respectively, in order to charge the reactor with the precursors and the substrate. Two heated catalytic chambers 15 and 19 are provided, each having a temperature monitoring apparatus 16 and 20 respectively.

Introduction of the liquid precursors prior to exposure to the catalyst is achieved in a first cruciform pipework intersection, shown schematically at 13. Mixing of the precursors before introduction to the catalyst bed is avoided by use of internal pipework. The temperature of the input of the precursors is monitored by temperature monitor 14. The inlet pipework of one precursor may direct the one precursor away from an introduced stream of a second precursor.

Mixing of the substrate with the products emerging from catalyst chamber 1 is achieved in a second cruciform pipework intersection, shown schematically at 17. The temperature of the substrate input is monitored by temperature monitor 18.

The product output from catalyst chamber enters a T-shaped pipework intersection 21, where its temperature is monitored by temperature monitor 22. The output product can be tapped off at sample collector 25.

A back pressure regulator 24 is fitted between the tap 23 and sample collector 25, in order to maintain a constant pressure within the reactor.

Chamber 15 is a gas-production chamber, and chamber 19 is a chemical reactor chamber in which the gases react with the substrate.

Of course, in other arrangements only one chamber may be necessary, but a plurality of chambers allows different conditions to exist in the different chambers. There may be more than one reaction chamber. The gas mixture produced may not take part in the reaction—for example it may be a supercritical fluid or dense phase gas solvent in which reactions of other chemicals occurs.

### EXAMPLES

Examples 1 and 2 below illustrate the use of supercritical fluids according to the present invention in the hydrogenation of trans-cinnamaldehyde and the effect of changing the flow rates of the precursors (formic acid and ethyl formate) on the yield of the desired product (hydrocinnamaldehyde) and on the amount of by-product (3-phenyl-1-propenol).

### Example 1

### Hydrogenation of Trans-Cinnamaldehyde

The equipment was set up as shown in FIG. 1. The catalyst chamber 1 (15) was charged with Deloxan AP II (Pt) 5% and maintained at a temperature of 400° C. (16). Catalyst chamber 2 (19) was charged with Deloxan AP II (Pd) 5% and maintained at a temperature of 180° C. (20). Formic acid and ethyl formate (precursor materials) were each charged to separate pumps (2 and 6) and entered catalyst chamber 1 (15) at flow rates of 0.2 and 0.2 ml/min respectively. The pressure of the reactor was maintained at 200 bar by means of back pressure regulator (24). At this temperature and pressure a supercritical liquid or dense phase fluid is formed (carbon dioxide, hydrogen, and ethane). Trans-cinnamaldehyde was charged to the substrate pump (10) from the reservoir. This was pumped into catalyst chamber 2 (19) at a flow rate of 0.05 ml/min. A solution containing the product was collected from the exit of the back pressure regulator (24) in an ice-cooled vial (25). Analysis of the solution by gas chromatography and ¹H NMR spectroscopy showed that the product was hydrocinnamaldehyde and that the yield was 65%. Gas chromatography and NMR analysis identified a yield of 30% of a second product, 3-phenyl-1-propenol.

### Example 2

### Hydrogenation of Trans-Cinnamaldehyde

The equipment was set up as shown in FIG. 1. The catalyst chamber 1 (15) was charged with Deloxan AP II (Pt) 5% and maintained at a temperature of 400° C. (16). Catalyst chamber 2 (19) was charged with Deloxan AP II (Pd) 5% and maintained at a temperature of 180° C. (20). Formic acid and ethyl formate were each charged to separate pumps (2 and 6) and entered catalyst chamber 1 (15) at flow rates of 0.1 and 0.4 ml/min respectively. The pressure of the reactor was maintained at 200 bar by means of a back pressure regulator (24). Trans-cinnamaldehyde was charged to the substrate pump (10). This was pumped into catalyst chamber 2 (19) at a flow rate of 0.05 ml/min. A solution containing the product was collected from the exit of the back pressure regulator (24) in an ice cooled vial (25). Analysis of the solution by gas chromatography and ¹H NMR spectroscopy showed that the product was hydrocinnamaldehyde and that the yield was 90%. Gas Chromatography and NMR analysis identified a yield of only 5% of a second product, 3-phenyl-1-propenol. Thus, changing the precursor flow-rates resulted in significant improvement in the yield of the desired product.

### Example 3

### Production of Cyclohexane Without Ethyl Formate

The equipment was set up as in FIG. 1. The catalyst chamber 1 (15) was charged with Deloxan AP II (Pt) 5% and maintained at a temperature of 400 C (16). Catalyst chamber 2 (19) was charged with Deloxan AP II (Pd) 5% and maintained at a temperature of 80° C. (20). Formic acid was charged to pump (2) and entered catalyst chamber 1 (15) at a flow rate of 0.2 ml/min. The pressure of the reactor was maintained at 80 bar by means of a back pressure regulator (24). Cyclohexene was charged to the substrate pump (10). This was pumped into catalyst chamber 2 (19) at a flow rate of 0.5 ml/min. A solution containing the product was collected from the exit of the back pressure regulator (24) in an ice cooled vial (25). Analysis of the solution by gas chromatography and ¹H NMR spectroscopy showed that the product was cyclohexane and that the yield was 100%.

### Example 4

### Production of Tetrahydrofuran Without Formic Acid (Etherification)

The equipment was set up as in FIG. 1 and maintained. The catalyst chamber 1 (15) was charged with Deloxan AP H (Pt) 5% and maintained at a temperature of 400 C (16). Catalyst chamber 2 (19) was charged with Amberlyst-15™ and maintained at a temperature of 180 C (20). Ethyl formate was charged to pump (6) and entered catalyst chamber 1 (15) at a flow rate of 0.4 ml/min. The pressure of the reactor was maintained at 200 bar by means of a back pressure regulator (24). 1,4-butanediol was charged to the substrate pump (10). This was pumped into chamber 2 (19) at a flow rate of 0.5 ml/min. A solution containing the product was collected from the exit of the back pressure regulator (24) in an ice cooled vial (25). Analysis of the solution by gas chromatography and ¹HNMR spectroscopy showed that the product was tetrahydrofuran (THF) and that the yield was 100% (see Table 1).

### Example 5

### Attempted Production of Hydrocinnamaldehyde at 120 Bar

The equipment was set up as in FIG. 1. The catalyst chamber 1 (15) was charged with Deloxan AP II (Pt) 5% and maintained at a temperature of 400° C. (16). Catalyst chamber 2 (19) was charged with Deloxan AP II (Pd) 5% and maintained at a temperature of 100° C. (20). Formic acid was charged to pump (2) and entered catalyst chamber 1 (15) at a flow rate of 0.4 ml/min. The pressure of the reactor was maintained at 120 bar by means of a back pressure regulator (24). Trans-cinnamaldehyde was charged to the substrate pump (10). This was pumped into catalyst chamber 2 (19) at a flow rate of 0.05 ml/min. A solution was collected from the exit of the back pressure regulator (24) in an ice-cooled vial (25). Analysis of the solution by gas chromatography and NMR spectroscopy showed that no reaction had occurred.

### Example 6

### Production of Hydrocinnamaldehyde at 150 Bar

The equipment was set up as in FIG. 1. The catalyst chamber 1 (15) was charged with Deloxan AP II (Pt) 5% and maintained at a temperature of 400° C. (16). Catalyst chamber 2 (19) was charged with Deloxan AP II (Pd) 5% and maintained at a temperature of 100° C. (20). Formic acid was charged to pump (2) and allowed to enter catalyst chamber 1 (15) at flow rate of 0.4 ml/min. The pressure of the reactor was maintained at 150 bar by means of a back pressure regulator (24). Trans-cinnamaldehyde was charged to the substrate pump (10). This was pumped into catalyst chamber 2 (19) at a flow rate of 0.05 ml/min. A solution containing the product was collected from the exit of the back pressure regulator (24) in an ice-cooled vial (25). Analysis of the solution by gas chromatography and NMR spectroscopy showed that the product was hydrocinnamaldehyde and that the yield was 38%.

### Example 7

### Production of 1,3,5,-trimethyl, 4-isopropylbenzene

The equipment was set up as in FIG. 1. The catalyst chamber 1 (15) was charged with Deloxan AP II (Pt) 5% and held at a temperature of 400 C (16). Catalyst chamber 2 (19) was charged with Nafion SAC-13 and held at a temperature of 200 C (20). Ethyl Formate was charged to pump (2) and allowed to enter catalyst chamber 1 (15) at a flow rate of 0.4 mL/min. The pressure of the cell was maintained at 100 bar by means of a backpressure regulator (24). 1,3,5-trimethylbezene was charged to the substrate pump (10). This was pumped into chamber 2 (19) at a flow rate of 0.05 mL/min. A solution containing the product was collected from the exit of the backpressure regulator (24) in an ice cooled vial (25). Analysis of the solution by gas chromatography and ¹H NMR spectroscopy showed that a reaction had occurred; 1,3,5-trimethyl,4-isopropylbenzene was identified as the only product, with a conversion of 45%.

### Example 8

### Production of 3 methyl,4-isopropylphenol

The equipment was set up as in FIG. 1. The catalyst chamber 1 (15) was charged with Deloxan AP II (Pt) 5% and held at a temperature of 400 C (16). Catalyst chamber 2 (19) was charged with Nafion SAC-13 and held at a temperature of 200 C (20). Ethyl formate was charged to pump (2) and allowed to enter catalyst chamber 1 (15) at flow rate of 0.4 mL/min. The pressure of the cell was maintained at 300 bar by means of a back pressure regulator (24). M-cresol was charged to the substrate pump (10). This was pumped into chamber 2 (19) at a flow rate of 0.01 mL/min. A solution containing the product was collected from the exit of the back pressure regulator (24) in an ice cooled vial (25). Analysis of the solution by gas chromatography and ¹H NMR spectroscopy showed that the product was 3-methyl, 4-isopropyphenol as the only product and the yield was 30%.

FIG. 2A shows two precursor liquids 50 and 52 being metered and provided by precursor supply control meters 54 and 56 and shows the two liquids mixing before non-return valve 58. This may be permissible if the two liquids do not react together, or if they do react together but the reaction products are indeed what is wanted for introduction to the reaction chamber.

FIG. 2B shows two liquids 50′ and 52′ mixing after passing through respective non-return valves 58′ and 60. This prevents any contamination of the liquids 50′ and 52′ in liquid reservoirs 62 and 64.

FIG. 2C schematically shows a precursor liquid 70 in a precursor liquid reservoir 72, where the liquid 70 is made of two different liquid substances, schematically shown as 74 and 76. The liquids 74 and 76 may be miscible or immiscible.

FIG. 3 shows a micro-production facility similar to that of FIG. 1, except that it has a gas liquid chromatograph (GLC) 80 which takes an on-line sample of what is being produced and analyses it. An infrared spectrometer 82 is also shown taking an on-line sample for on-line analysis.

The GLC and/or IR spectrometer could be at a different place in the production line, and/or samples from more than one place in the reaction sequences could be analysed.

FIG. 4 shows a micro-reactor plant 90 having a reaction chamber 92, precursor liquids 94, 96, 98 held in reservoirs 95, 97 and 99, metering pumps 100, 102, 104, pressure sensors 106, 108, 110, precursor inflow lines 112, 114, 116 leading to chamber 92, a pressure sensor 118 in chamber 92, a temperature controller 120 to control the temperature in chamber 92, a temperature sensor 122 in chamber 92, a back pressure regulator/pressure controller 124 controlling the pressure in chamber 92, a product collection reservoir 126, a gas/liquid chromatograph 128, an infrared spectrometer 130, and a microprocessor controller 132.

The controller 132 receives sensor signals from the sensors and output control signals to the pumps 100, 102, 104, the temperature controller 120, the pressure regulator 124, and the IR and GLC 128 and 130. The IR and GLC also provide information/analysis signals to the processor 132. The total volume of the chamber 92 and pipe work from reservoirs 92, 96, 98 to the chamber 92 is about 5 ml.

The processor 132 can be programmed by a user to pump a known and carefully controlled amount of precursors 94, 96 and 98 (sometimes different amounts of each, sometimes the amounts may be the same) to the chamber 92 where the liquid precursors become gaseous. In many examples the pressure and temperature in chamber 92 is such that gaseous precursor materials, or their reaction products, become supercritical fluids. Chemical reaction occurs in the chamber 92, the course of the reactions occurring in chamber 92 being controlled by the temperature, pressure, and amounts of precursor allowed into the chamber. The reaction products are analysed in an on-line process, which may be continuous, by IR and/or GLC. The processor 132 can control conditions responsive to the feedback it receives from the sensors.

The processor 132 may be programmable by a user to produce different, selectable, reaction products, possibly from the same starting precursors, or possibly using different precursor substances.

By using small pilot, or laboratory, scale equipment for supercritical fluid reactions, but starting with relatively cheap or common starting materials (e.g. simple, small, organic molecules) has the advantage that if a reaction product of interest is made, it is relatively simple to produce the same reaction product from the same or similar starting precursors in a larger production facility. This approach contrasts with traditional laboratory synthesis of new substances, which typically uses complex and expensive starting materials to prove that a particular substance can be synthesised. Industrial chemists usually have to redesign the synthetic pathway typically using cheaper starting materials to make the large scale synthesis economically viable. In this new approach the laboratory synthesis chemist uses the same starting materials that are commonly available to the industrial chemist.

In some embodiments we may make the gases from liquid precursors, and mix them and/or react them with each other, and possibly with another substance, in a chamber.

This method may also be conveniently used to convert Paraformaldahyde (CHO)ₙ to CO+H₂, (an industrially important gas mixture known as Syngas). The ratio of CO to H₂ may be varied in Syngas for different purposes. Different customers want a different mix. In our method, the ratio of CO to H₂ can be easily varied by judicious use and combination of two or more of the following reactions;

(1) (CHO)ₙ→CO+H₂

(2) HCOOH→H₂O+CO.

(3) Indeed, any liquid→X+H₂

(4) or liquid→Y+CO

which can be used to vary the amount of H₂ versus CO in the resulting mixture of gases.

Thus, by varying the proportions of the liquid precursors (for example by changing their respective flow rates) we can vary the ratio of the resultant components within the gas mixture.

The reaction HCOOC₂H→CO₂+C₂H₆ is interesting because ethane has a relatively low critical point. We can use HCOOC₂H₅ specifically to create a supercritical ethane/carbon dioxide mixture. This mixture can be used as a vehicle for chemical reactions, or drying biological materials, to name but two uses.

Another useful reaction is: HCOOCH₃→CH₄+CO₂. We have made supercritical fluids using this. It will be appreciated that in the examples given in the Figures, the liquid precursors are delivered to the chamber 15 in liquid form and turn into gas in the chamber. They may then turn into a dense phase gas or supercritical fluid.

FIG. 5A shows a chemical reactor 200 having a gas-production chamber 202 and a chemical reaction chamber 204. A liquid precursor 206 to a gas is introduced to the chamber 204 via port 208, A substance 210 is introduced to the chamber 202 via port 212. The gas produced from the precursor 206 and the substance 210 flow into the reaction chamber 204 where a chemical reaction takes place. The chamber 204 typically, but not always, has a catalyst 214 to facilitate the chemical reaction. A reaction product 216 leaves the chamber 204 via port 218.

The substance 210 may be a liquid precursor to a gas, or a gas itself, or a liquid, or a solid. The chemical reaction in chamber 204 preferably takes place in the supercritical fluid or dense phase gas state. The gas/substance mixture (or compound or mixture of compounds if they react) is preferably in the supercritical fluid or dense phase gas state in the chamber 202 and/or chamber 204. The liquid precursor 206 may be involved in the chemical reaction in the chamber 204, or it may not. The substance 210 may be involved in the chemical reaction or it may not (either of the gas from the precursor 206 or the substance may simply be a supercritical fluid/dense phase gas).

FIG. 5B shows a reactor 220 that is similar to that of FIG. 5A, except that no substance 210 is introduced. Similar components have been given similar reference numerals.

FIG. 5C shows a variant on the chemical reactor arrangement. Reactor 230 has a first gas production chamber 202a and a second gas production chamber 202b. The chamber 202a receives liquid precursor 206″. The chamber 202b receives a substance 210″, which may be a gas, or a liquid precursor which experiences a chemical change to become a gas, or it may be a liquid which experiences a physical change to become a gas. Gas from chambers 202a and 202b mix in pipework 232 and a chemical substrate 234 is introduced at or prior to a chemical reactor 204″.

FIG. 5D shows a variant discussed above where the substance 210″ of FIG. 5C is itself a liquid precursor, precursor 206(b), and precursor 206″ is also a liquid precursor (206a), both liquid precursors experiencing a chemical change to produce different gases or gas mixtures which are mixed prior to (or in some cases after) the introduction of a chemical substrate 234″.

It will be appreciated that in preferred embodiments of the chemical reactors of FIGS. 5A to 5D the reactors comprise supercritical or dense phase fluid chemical reactors adapted to synthesise chemicals.

One way of looking at some embodiments of the invention is that we can provide supercritical fluids without gases as the starting point.

In summary, in one embodiment a gas or mixture of gases is produced by decomposition or chemical reaction of liquid precursor(s). The gas may be converted to a dense phase or supercritical fluid state which can be used as a medium for chemical reactions, chromatography, extraction or impregnation/modification of solid substrates. Changes in the gas composition may be made simply by modification of the metered flow rates or chemical composition of the liquid precursor(s).

The invention is performed, preferably, in a continuous flow reactor.

1. A method of producing a gas or mixture of gases having gas components, comprising the steps of: storing one or more liquid chemical precursor(s) to the gas, or gas component(s), in liquid form and turning the liquid chemical precursor(s) into said gas, or mixture of gases, the gas or at least one of the gas components being the product of either a chemical reaction or decomposition of the liquid chemical precursor(s).

2. A method according to claim 1 in which the liquid chemical precursor(s) is/are tuned into the gas or gas mixture at a time of demand for said gas or gas mixture.

3. A method according to claim 1 or claim 2 in which the liquid chemical precursor(s) is/are turned into said gas or mixture of gases in at or near to a gas mixing chamber at which said gas component, or mixture of gas components encounters a further gas component.

4. A method according to any preceding claim in which the gas or mixture of gases is introduced into a chamber and in which the pressure and temperature in the chamber are such that a dense phase gas or supercritical fluid is formed.

5. A method according to any preceding claim in which the gas, or at least one of the gas components, is a decomposition product of a higher molecular weight liquid precursor molecule.

6. A method according to any preceding claim in which there are a plurality of different liquid chemical precursors, each of which turns into a gaseous component of a mixture of gases.

7. A method according to any preceding claim in which the or each liquid chemical precursor is metered out in a controlled manner.

8. A method according to any preceding claim comprising producing a mixture of gas components, and in which the proportions of the said gas components are controlled by varying the amount of, or metered flow rates of, said liquid chemical precursor(s).

9. A method according to any preceding claim in which another input material is present, and the proportions of the said gas components are controlled by varying the relative amount of, or entered flow rates of, said liquid chemical precursor(s) in comparison with the amount of said another input material.

10. A method according to claim 9 in which said another input material comprises one of:—
(i) a gas;
(ii) a precursor material which has a reaction product which is a gas;
(iii) a liquid precursor(s) from which is derived a gas component(s) which comprises some other liquid input material.

11. A method according to any preceding claim in which at least one liquid chemical precursor to the gas, or to a gas component, is used from the group:—
organic acid, ester of an organic acid, formate, carbonate or salt of the afore mentioned.

12. A method according to any preceding claim in which the liquid chemical precursor comprises one of, or at least one of;
(i) HCOOH
(ii) HCOOC₂H₅
(iii) HCOOCH₃
(iv) HCOOC₃H₇
(v) (CHO)ₙ, where n is greater than or equal to unity
(vi) H₂O

13. A method according to any preceding claim in which at least one liquid chemical precursor to the gas or to a gas component comprises two, or more, of substances from the group;
(i) HCOOH
(ii) HCOOC₃H₅
(iii) HCOOCH₃
(iv) HCOOC₃H₇
(v) (CHO)ₙ, where n is greater than or equal to unity
(vi) H₂O

14. A method according to any preceding claim, in which said liquid chemical gas precursor comprises a mixture of formic acid and ethyl formate.

15. A method according to any preceding claims in which a plurality of liquid chemical gas precursors are provided from the list:
(i) HCOOH
(ii) HCOOC₂H₅
(iii) HCOOCH₃
(iv) HCOOC₃H₇
(v) (CHO)ₙ, where n is greater than or equal to unity
(vi) H₂O

16. A method according to any preceding claim in which said liquid chemical precursor comprises methyl formate, propyl formate, dimethyl carbonate or any mixture thereof.

17. A method according to any preceding claim in which said liquid chemical precursor liquid is decomposed or chemically reacted to form said gas or at least one said gas component.

18. A method according to any preceding claim in which said liquid chemical precursor(s) react over a catalyst to form a gas or at least one gas component(s).

19. A method according to any preceding claim in which the gas, or a component of the aforementioned gas mire, takes part in a chemical reaction after it has been produced.

20. A method according to any one of claims 1 to 18 in which the gas, or any component of the gas mixture, does not take part in a subsequent chemical reaction.

21. A method according to claim 18, in which the catalyst comprises any heterogeneous catalyst.

22. A method according to any preceding claim, in which the rate at which the liquid chemical precursor, or any one or more of the precursor(s), flows into a chamber is adjusted In accordance with the results to be achieved.

23. A gas or gas mixture produced by the method of any of the preceding claims.

24. A dense phase gas or supercritical fluid produced by the method of any one claim 1 to 22.

25. A reaction product produced in a supercritical fluid or dense phase gas produced by the method of any one of claims 1 to 22.

26. Apparatus for producing a gas mixture having a plurality of gas components, the apparatus comprising a gas mixture containing chamber, a means adapted to provide a first substance to the chamber, and second substance supply means adapted to provide a second substance to the chamber, a first gas component being derivable chemically from said first liquid precursor chemical substance by chemical reaction or decomposition, and a second gas component being derivable from said second substance, and in which said first substance supply means comprises a first liquid reservoir adapted to hold a liquid chemical precursor first substance, and a transport channel adapted to transport the liquid chemical precursor first substance to the chamber, there being metering means adapted to transport a controlled amount of said first liquid chemical precursor substance to said chamber; there also being temperature control means associated with the chamber, and pressure control means associated with the chamber, said temperature and pressure control means being adapted to control the temperature and pressure in said chamber, the conditions in the chamber being arrangeable such that said first liquid chemical precursor substance produces said first gas component in said chamber by chemical reaction or decomposition.

27. A supercritical fluid or dense phase fluid medium chemical reactor comprising:
a reaction vessel adapted for performing chemical reactions in dense phase or supercritical fluids;
a gas generator;
a gas communication channel from the gas generator to the reactor vessel;
in which the gas generator comprises an inlet for liquid chemical precursor and a means for providing chemical reaction or decomposition of the liquid chemical precursor so as to produce gas, and a liquid chemical precursor reservoir communicated to the inlet.

28. A reactor according to claim 27 in which there are a plurality of gas generators.

29. A reactor according to claim 27 or claim 28 in which an additional material introduction means is provided in the reactor vessel adapted to allow the introduction of an additional material.

30. A reactor according to claim 29 in which there is no further reactive substance introduced to the reactor vessel.

31. A reactor according to any of claims 27 to 30 which comprises a hydrogenator.

32. A reactor or apparatus according to any one of claims 26 to 31 in which a microprocessor or controller is provided adapted to control the temperature and pressure in the chamber or vessel, and to control the supply of either (i) said first and second substances to said chamber, or (ii) liquid chemical precursor to the gas generator.

33. Apparatus according to claim 26 or any one of claims 27 to 32 as they depend directly or indirectly from claim 26 in which said second substance supply means comprises a second liquid reservoir adapted to hold a liquid second substance, and a transport channel adapted to transport the liquid second substance to the chamber, and the conditions in the chamber being arrangeable such that said second liquid substance produces said second gas component in said chamber.

34. A reactor or apparatus according to any one of claims 26 to 33 in which pressure control means is provided adapted to create a pressure in said chamber or vessel, and/or gas generator, which is greater than atmospheric pressure.

35. A reactor or apparatus according to claim 34 in which the pressure control means comprises a back pressure regulator.

36. A reactor or apparatus according to any one of claims 26 to 35 in which temperature control means is provided adapted to produce a temperature which is greater than 15 degrees Celsius.

37. A reactor or apparatus according to any one of claims 26 to 36 which is provided with a means of analysis adapted to analyse the composition of materials.

38. Apparatus according to claim 26 or any claim dependent directly or indirectly from claim 26, comprising a supercritical fluid chemical reactor adapted to create a supercritical fluid in the chamber and to cause chemical reactions to occur in the presence of a gas mixture or dense phase/supercritical fluid.

39. A reactor or apparatus according to any one of claims 26 to 38 in which there is means adapted to control the relative amounts of substance(s) introduced into the chamber.

40. A reactor or apparatus according to claim 32 or any claim dependent directly or indirectly from claim 30, in which the microprocessor or controller is controllable by the user to cause the apparatus to produce selected different gas mixtures.

41. A process for producing a chemical comprising producing a supercritical fluid or dense phase gas in accordance with the method of any one of claims 1 to 22 and producing the chemical using the supercritical fluid or dense phase gas.

42. A chemical produced using the process of claim 41.

43. In a supercritical fluid or dense phase reactor, use of a liquid precursor from a liquid precursor reservoir to produce a derived gas by a chemical reaction or chemical decomposition of the liquid precursor, the derived gas being used in the supercritical fluid or dense phase reactor.
